(19) United States
(12) Patent Application Publication
(10) Pub. No.: US 2008/0187721 A1
(43) Pub. Date: Aug. 7, 2008

(54) BULLETPROOF WINDOW

(75) Inventor: Andreas ENGL, Munchen (DE)

Correspondence Address: LOWE HAUPTMAN HAM & BERNER, LLP, 1700 DIAGONAL ROAD, SUITE 300, ALEXANDRIA, VA, 22314, US

(73) Assignee: ISOCLIMA GMBH, Munchen (DE)

(21) Appl. No.: 12/024,713

(22) Filed: Feb. 1, 2008

(30) Foreign Application Priority Data
Feb. 2, 2007 (DE) 20 2007 001 565.8

(51) Int. Cl. B32B 3/02; C01B 21/20; B32B 17/06; B32B 3/30; B32B 27/40

(52) U.S. Cl. 428/172; 423/385; 428/426; 428/423.1; 428/192

(57) ABSTRACT

The present invention relates to an armoured glazing, particularly for use as a moveable side window of a motor vehicle, comprising at least one sheet (3) of an optically transparent, sintered ceramic material which is preferably aluminum oxynitride (AlON).

The present invention relates to armoured glazing in the form of laminated glazing, in particularly for use as a moveable side window of a motor vehicle.

Such laminated window glazing made of armoured glass for use in a motor vehicle is known from DE 198 082 C5. This known safety glazing comprises a plurality of glass sheets arranged in a sandwich structure, of which the most outside glass sheet projects beyond the other glass sheets at the edge of the armoured glazing to form a stepped edge having a projection from the periphery of the armoured glazing for engagement in a frame of the vehicle chassis. A frame as an armoured member or a metal armour made of sheet steel at the stepped edge prevents projectiles that strike the edge of the armoured glazing at an unfavourable angle from penetrating the relatively thin glass projection. However fabricating the frame made of steel is time-consuming, for instance, due to the welds at the corners of the frame in order to comply with the necessary tolerances.

In EP 1004433 B1, armoured glazing is described which may be used as a windscreen of a motor vehicle. The bulletproof window comprises a plurality of glass sheets laminated. Due to the large areas of windscreens and other armoured glazing, such glazings have a corresponding high weight to satisfy the ballistic performance requirements and often take up a lot of space, which significantly adds to fuel consumption of the vehicles in which the known armoured glazings are fitted, and which also means the vehicle chassis needs to be adapted in design to these armoured glazings.

The object of the present invention is to define an armoured glazing which, without deteriorating the ballistic performance, now diminishes the extra design outlay in e.g. adapting the motor vehicle chassis.

This object is achieved by the armoured glazing as it reads from claim 1 by which the armoured glazing of the invention as may be used particularly for a moveable side window for raising and lowering comprises at least one sheet of an optically transparent sintered ceramic material, preferably aluminum oxynitride (AlON) being used as the ceramic material. By using one or more AlON sheets the resistance of the armoured glazing to projectiles and impact is substantially improved. On top of this, the AlON sheets now make it possible to design the armoured glazing of the invention substantially thinner with just the same resistance as armoured glazing using only glass sheets in thus achieving a considerable reduction in weight and volume of the armoured glazing.

In one preferred embodiment of the invention at least one of the sheets is an AlON sheet, a first outer sheet being made of AlON or glass and a second sheet as an inner sheet to the first sheet being an AlON sheet or a glass sheet, a laminating layer between the first sheet and the second sheet being made of polyurethane, polyvinylbutyral, ethylene vinyl acetate, polyester, polyethylene or an acrylic plastic material. Using these plastics surprisingly showed that the light transparency of the AlON sheet(s) involved is unexpectedly improved. This is attributed to the pores or flaws at the surface of the AlON sheet which otherwise would detriment the light transparency because of scatter are probably filled by the plastics coating or laminating layer, resulting in scatter being considerably reduced.

Forming a stepped edge at a periphery of the armoured glazing produces a projection for engaging the armoured glazing in a frame or door frame so that the armoured glazing is securely held in a receiving slot. The projection may also be made of AlON.

An outer first sheet of the armoured glazing may be an AlON sheet configured in one piece with the projection, improving the ballistic performance of the armoured glazing.

A second sheet sited further inwardly of the first sheet may be made of AlON and configured in one piece with the projection to achieve a more rugged structure of the armoured glazing in preventing the projection from being sheared off.

For this purpose, also a third sheet following the second sheet further inwardly can also be made of sintered AlON and configured in one piece with the projection.

The invention also relates to armoured glazing as it reads from claim 11 which can also be used particularly as a moveable side window of a motor vehicle and comprising a plurality of sheets and laminating layers in a laminate, at least one laminating layer being arranged between the two successive sheets to connect both sheets, a stepped edge configured at the periphery of the armoured glazing and having a projection for engaging the armoured glazing in a frame or door frame, and featuring an edge reinforcement covering at least the inside surface of the projection, in the region of the stepped edge, a recess being configured at the periphery of the armoured glazing into which the edge reinforcement extends which may consist of a sintered ceramic part. The sintered ceramic part can be produced with practically any cross-section, e.g. also with the edge reinforcement curved, sintered with high accuracy, so that even complicated shapes of the edge reinforcement can be produced for good ballistic performance.

The armoured glazing has preferably at least one outer sheet, at least one inner sheet and at least one middle sheet arranged between the outer sheet and the inner sheet, the outer sheet protruding beyond the middle sheet or beyond the other sheets to form the projection at the edge and periphery of the armoured glazing, the inner sheet protruding in the region of the projection beyond the middle sheet to form the recess between the inner sheet and the outer sheet, and the edge reinforcement being made of aluminum oxynitride (AlON) as sintered ceramic material. Because the AlON edge reinforcement engages the recess this prevents shearing off of the projection and collapse of the armoured glazing into the vehicle interior when the window is impacted from outside.

The reinforcement is preferably applied by means of a layer of polyurethane, polyvinylbutyral, ethylene vinyl acetate, polyester, polyethylene or an acrylic plastic material to the adjoining glass sheet or outer glass sheet, achieving a secure lamination.

A middle sheet of the sandwich structure of the armoured glazing is preferably made of transparent, sintered ceramic, preferably AlON. Using AlON as the material achieves a good ballistic performance coupled with good light transparency.

A middle sheet and the edge reinforcement of the armoured glazing can be produced in one piece of transparent, sintered ceramic, preferably AlON, with which an armoured glazing having surprisingly good ballistic performance can be fabricated.

The outer sheet and/or the inner sheet of the armoured glazing can be made of glass or transparent, sintered ceramic, preferably AlON.

The armoured glazing in accordance with the invention may comprise a laminate of sheets and laminating layers, at least one laminating layer being arranged between each two successive sheets to laminate the sheets and laminating layers together, and a stepped edge configured at the periphery of the armoured glazing and a projection for engaging the armoured glazing in a frame or door frame, the projection being made of a sintered ceramic, preferably aluminium oxynitride (AlON).

The armoured glazing can have a frame extending continuously along at least part of the periphery of the armoured glazing and may include the projection. The frame can again be a sintered ceramic part, particularly of AlON, improving the ballistic performance of the frame and thus also of the whole armoured glazing of the invention.

The armoured glazing may comprise a ballistic sheet or ballistic laminate having a periphery or face to which the frame is applied.

The frame or partial frame of the armoured glazing can be mounted to the periphery of the ballistic sheet or laminate by means of a layer of polyurethane, polyvinylbutyral, ethylene vinyl acetate, polyester, polyethylene or an acrylic plastic material, resulting in a secure lamination.

Preferably the laminate may have at its periphery a recess and the armoured frame may have a ridge or rib extending into the recess to achieve a frame having a particularly good ballistic performance.

The laminate can comprise at least one outer sheet, at least one inner sheet and at least one middle sheet arranged between the outer sheet and inner sheet, the outer sheet and the inner sheet extending protruding beyond the periphery of the laminate to form the recess in thereby simplifying fabrication of the armoured glazing.

The frame and at least one of the sheets of the laminate can be configured in one piece to improve the stability of the armoured glazing.

An inner surface of the armoured glazing of the invention can be provided with a layer of polycarbonate or its inner surface can be provided with a sandwich of polyurethane and polycarbonate layers to prevent shatter into the vehicle interior.

The armoured glazing of the invention may comprise a heating layer or heating means.

The armoured glazing of the invention may comprise a layer reflecting outer infrared radiation.

The armoured glazing of the invention may comprise a sheet of tinted or coloured transparent glass or AlON.

The armoured glazing of the invention may comprise an opaque section or opaque layer.

The armoured glazing of the invention may be put to use generally in a vehicle, e.g. in a ship, aircraft, a car. Furthermore the armoured glazing of the invention can be put to use in a building or a facade. Furthermore the armoured glazing of the invention may feature a curved or bent cross-section. Further advantageous embodiments of the present invention read from the sub-claims.

Further advantages, advantageous further aspects and possible applications of the present invention read from the following description of embodiments of the invention by way of example and as preferred in conjunction the drawings that show:

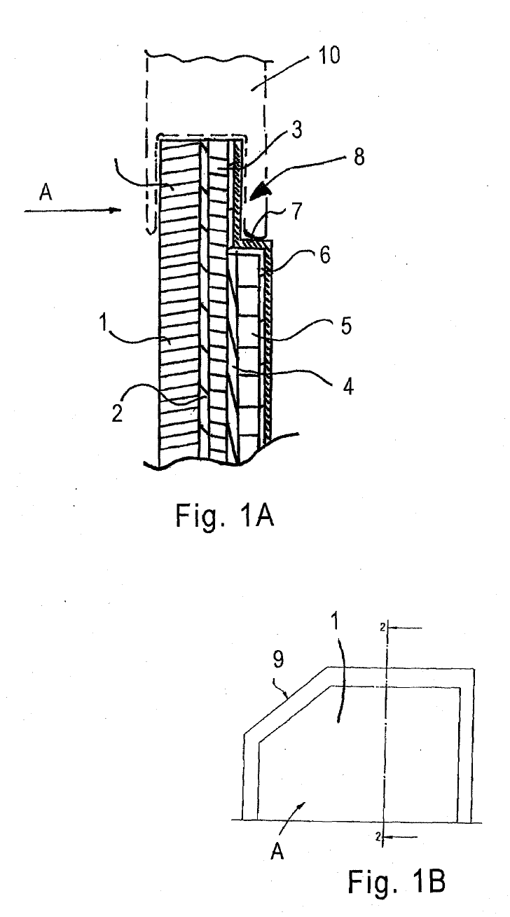

FIG. 1A a partial cross-sectional view of a first embodiment of the armoured glazing of the present invention taken along the section line 2-2 of FIG. 1B with a vehicle frame indicated by the broken line;

FIG. 1B a view of an armoured glazing of the invention;

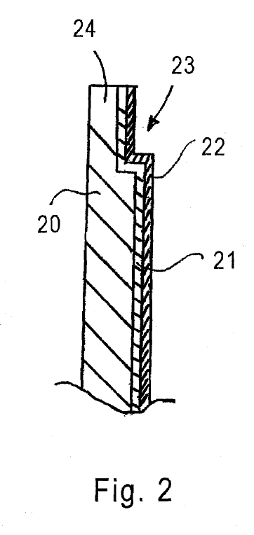

FIG. 2 a partial cross-sectional view of a second embodiment of the armoured glazing of the present invention;

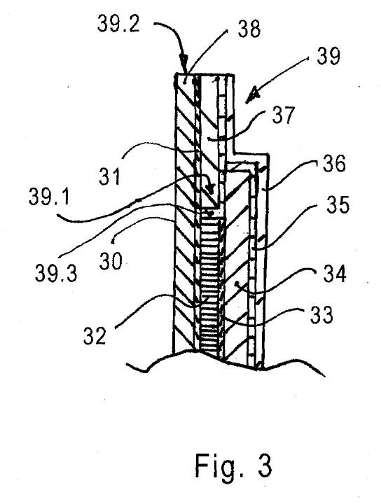

FIG. 3 a partial cross-sectional view of a third embodiment of the armoured glazing of the present invention;

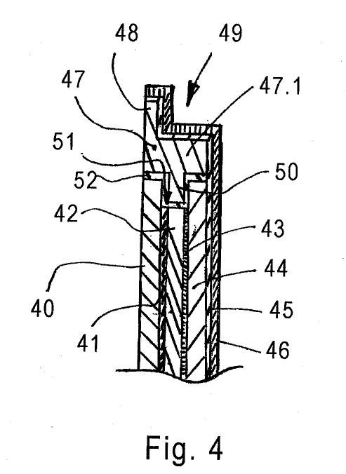

FIG. 4 a partial cross-sectional view of a fourth embodiment of the armoured glazing of the present invention; and

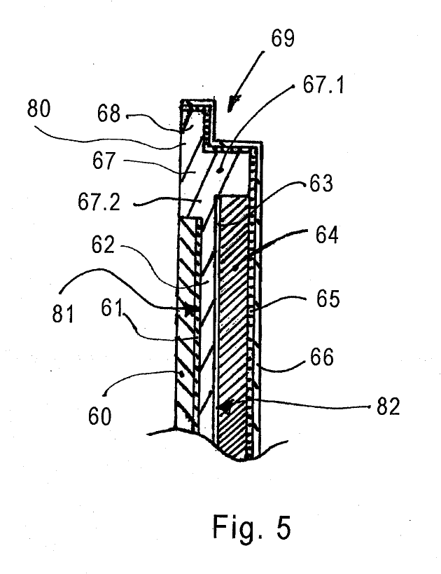

FIG. 5 a partial cross-sectional view of a fifth embodiment of the armoured glazing of the present invention.

Referring now to FIG. 1 there is illustrated a first embodiment of the armoured glazing in accordance with the invention, preferably configured as transparent laminated safety glazing and comprising a plurality of glass sheets 1 and 5, a sheet 3 of aluminum oxynitride (termed AlON sheet hereinafter) and a plurality of laminating layers 2, 4 and 6. In the following the embodiment as shown in FIG. 1 of the invention is described in detail assuming use of the armoured glazing in accordance with the invention as a moveable motor vehicle side window, i.e. for raising and lowering. Used generally preferred as AlON is Al_{(64+x)/3}O₃₂₋ₓNₓ where x is preferably in the range 2≦x≦5.

The armoured glazing of the invention as shown in FIG. 1 comprises two laminated glass sheets 1 and 5, the third inner sheet 5 being arranged facing the vehicle interior and the first outer glass sheet 1 facing the vehicle exterior from which a projectile or impact would be coming. The second middle sheet 3 interpolated between the outer glass sheet 1 and the inner glass sheet 5 is an AlON sheet made from a sintered AlON as the transparent, sintered ceramic material. The outer side of the vehicle is indicated by the arrow A in FIG. 1 pointing in the direction of the outer glass sheet 1. Extending between the outer glass sheet 1 and the middle AlON sheet 3 is a polyurethane layer 2 forming a laminating layer between the outer glass sheet 1 and the middle AlON 3. The polyurethane laminating layer 2 or polyurethane film is sized to fully cover the surface of the outer glass sheet 1 and follows the outline of the outer glass sheet 1. Between the middle AlON sheet 3 and the inner glass sheet 5 there is configured e.g. a further polyurethane layer 4 in turn forming a secure lamination between these adjoining sheets. The polyurethane layer 4 is sized to fully cover the adjoining surface of the inner glass sheet 5.

The outer glass sheet 1 and the AlON sheet 3 protrude beyond the inner glass sheet 5 together with the polyurethane layer 2 arranged in between at the edge or periphery of the armoured glazing, resulting in a projection 9 being formed at the edge which declines via a stepped edge 8 or a grading to the inner glass sheet 5.

The projection 9 is supported in a frame 10 of the motor vehicle as indicated by the broken line cross-section as shown in FIG. 1 and running in the region of the motor vehicle roof. In the position as shown in FIG. 1 the armoured glazing engages the frame 10 by the projection 9. The armoured, bullet-proof and moveable side window is thus shown raised in FIG. 1 and the window is closed.

In one example of the armoured glazing of the invention the outer glass sheet is 3 mm thick, the AlON sheet 3 and the inner glass sheet 5 are each 2 mm thick. Each of the polyurethane layers is 1 mm thick.

The complete inner surface of the armoured glazing is further covered with a polyurethane layer 6 and a polycarbonate layer 7 in this sequence of layers, this additional polyurethane layer being approx. 1 mm thick and the polycarbonate layer is approx. 1 mm thick.

In producing the armoured glazing as shown in FIG. 1 first the AlON sheet as the AlON part is made of powdery starting materials by the steps A to E in the method as described in the following.

More accurately, a substantially homogenous powder of aluminum nitride (AlON) is used to produce the transparent, sintered AlON sheet or AlON part. In a stepped edge A the AlON powder is generated from a blend of 25 to 45 mol % aluminum nitride in the form of commercially available fine-particle powder of high purity and 75 to 55 mol % aluminum oxide again in the form of commercially available fine-particle powder of high purity, the particle sizes of the powders being smaller than e.g. 75 micron.

In a step B, this blend is ground e.g. in a ball mill for e.g. 17 hours with the addition of an aluminum grinding agent and methanol. Then, in a process step C, the blend is calcinated in a crucible at approx. 1600° C.-1750° C. in a nitrogen atmosphere to obtain a powder of cubic aluminum oxynitride which is then again ground e.g. in a ball mill with the addition of an aluminum grinding agent and methanol. The resulting AlON powder has an average particle size of smaller than 20 micron, but preferably smaller than 1 micron.

In a step D after a drying step, the AlON powder is then isostatically compressed at a pressure of approx. 17000 psi in a mold designed in a sheet size corresponding to the sheet size of the AlON sheet to be generated or corresponding to the respective AlON part to be generated to obtain an AlON blank sheet as a molded AlON blank part.

In a sintering step E, this AlON blank sheet or AlON blank part is then sintered in an sintering furnace in a nitrogen atmosphere, sinter temperature and duration being set such that porosities or cavities in the AlON sheet or AlON part are avoided while simultaneously preventing too strong a grain growth to ensure high transparency of the AlON sheet or AlON part as produced. The sinter temperature can be in the range from 1800° C. to 2000° C. for a duration between 15 and 110 hrs. Prior to sintering, an evacuation step may be included to substantially remove air from the sintering furnace. Further, dopants such as yttrium or Y₂O₃ can be added in a small percentage in sintering to further reduce the porosity of the generated AlON sheet or AlON part. After the sinter step the produced AlON sheet or AlON part is allowed to cool to a relatively low temperature or ambient temperature.

Optionally, polishing and/or grinding the AlON sheet or AlON part can be implemented to further improve the light transparency of the AlON sheet or part.

In further fabrication of the armoured glazing, a film of polyurethane 1 mm thick—from a typical range for the film thickness between approx. 0.3 mm to 5 mm—is placed manually, semi- or fully automatically for full coverage of the facing surface of the outer glass sheet 1 and aligned so that the placed film of polyurethane covers the full inside surface of the glass sheet 1. Then, the AlON sheet 3 is placed on the polyurethane layer 2 and a further film of polyurethane is placed thereon as polyurethane layer 4. The sheets 1 and 3 and the laminating layer 2 are then aligned so that the outer glass sheet 1, the polyurethane layer 2 and the AlON sheet 3 are flush at the edges.

After this, the glass sheet 5 is placed on the polyurethane layer 4 such that armoured glazing for production obtains a peripheral stepped edge 8 evenly extending at the edge and having the projection 9.

The thus prepared laminate is then subjected to heat and compression in a so-called pre-laminating oven to produce a pre-laminate with partially plasticized films, this squeezing out practically all the trapped air from the laminate.

Then, the thus pre-treated laminate is placed in an autoclave in which for a precisely defined compression and temperature cycle the individual components of the pre-treated sandwich structure are interconnected. During the autoclave cycle the interior of the autoclave is heated to a temperature between 120° C. and 150° C., preferably 130°, at a high pressure of 12 to 15 bar, preferably 14 bar. Once target values of pressure and temperature are obtained, they are maintained for a holding period in the autoclave. After this, first the temperature, then the pressure in the autoclave is reduced and the laminate thus treated is removed.

Then, the inner surface of the thus treated laminate is covered by a further film of polyurethane as polyurethane layer 6 and this in turn is covered in this sequence by the polycarbonate layer 7. The thus prepared laminate is then again treated in the pre-laminating oven, as explained above, to remove the air from the laminate, after which the thus pre-treated laminate is placed in an autoclave in which in a precisely defined pressure and temperature cycle the individual components of the now pre-treatment sandwich structure are interconnected, using substantially the autoclave cycle as already explained.

In a modification of the first embodiment of the armoured glazing as shown in FIG. 1, the outer glass sheet 1 and/or the inner glass sheet 5 can be replaced by a further AlON sheet. In a further modification—e.g. depending on the particular application and wanted ballistic performance—the inner glass sheet 5 can be omitted so that also the stepped edge 8 is eliminated. In this case, the outer glass sheet 1 can be replaced e.g. by a thinner sheet of AlON without diminishing ballistic performance.

Referring now to FIG. 2 there is illustrated by way of example a second embodiment of the armoured glazing in accordance with the invention which again is configured as a laminated safety glazing and it substantially comprising a sheet of aluminum oxynitride (termed AlON sheet hereinafter) and which can be used as a moveable—i.e. which can be raised and lowered—side window of a motor vehicle.

The armoured glazing of the invention as shown in FIG. 2 features an AlON sheet 20 arranged in one piece sandwiched in the laminate, and being made from a sintered AlON as ceramic material. The AlON sheet 20 has at its edge or periphery a projection 24 limited by a stepped edge 23, the projection 24 being less thick than a middle portion of the AlON sheet 20. Here again, the projection 24 serves to permit moving the armoured glazing into a receiving slot in the frame of a motor vehicle.

Applied to the full inner surface of the armoured glazing as shown in FIG. 2 is a sandwich of layers comprising a polyurethane layer 21 and a polycarbonate layer 22 in this sequence. The polyurethane layer 21 may be, e.g. approx. 1 mm thick, the polycarbonate layer 22 approx. 1 mm thick. The AlON sheet 20 may be 3 mm thick at its projection, otherwise 5 mm thick.

In fabrication of the embodiment of the armoured glazing in accordance with the invention as shown in FIG. 2, the AlON sheet 20 is firstly made of the powdery starting materials the same as in the first embodiment as shown in FIG. 1 involving the steps A to E in the method, but now with the difference that in the compression step D a mold specially adapted to the AlON sheet 20 with the projection 24 and stepped edge 23 is employed.

In further fabrication of the armoured glazing as shown in FIG. 2, a film of polyurethane 21 1 mm thick—from a typical range for the film thickness between approx. 0.3 mm to 5 mm—is placed manually, semi- or fully automatically for full coverage of the facing surface of the outer glass sheet 1 and aligned so that the placed film of polyurethane covers the full inside surface of the AlON sheet 20. Then, the film of polycarbonate cut to size is placed as the polycarbonate layer 22 on the exposed surface of the polyurethane layer 21.

The thus prepared laminate is then subjected to heat and compression in a pre-laminating oven to produce a pre-laminate with partially plasticized films, this squeezing out practically all the air from the laminate.

Then, the thus pre-treated laminate is placed in an autoclave in which for a precisely defined compression and temperature cycle the individual components of the pre-treated sandwich structure are interconnected. During the autoclave cycle the interior of the autoclave is heated to a temperature between 120° and 150° C., preferably 130° C., at a high pressure of 12 to 15 bar, preferably 14 bar. Once pressure and temperature are as needed, they are maintained for a holding period in the autoclave. After this, first the temperature, then the pressure in the autoclave is reduced and the laminate thus treated is removed, this then corresponding to the finished product of armoured glazing as shown in FIG. 2. The exposed outer side of the AlON sheet 20 or of the armoured glazing in accordance with the invention can then be further polished or grinded to further improve its transparency to light.

A modification of the armoured glazing in accordance with the invention as shown in FIG. 2 is configured without the projection 24 and stepped edge 23 at the edge, i.e. the modification producing an AlON sheet of consistent thickness.

Referring now to FIG. 3 there is illustrated a further, third embodiment of the armoured glazing in accordance with the invention configured as a transparent laminated safety glazing comprising a plurality of glass sheets 30, 32 and 34 and a plurality of laminating layers 31, 33 and 35 and is used, for example, as a moveable side window of a motor vehicle.

In this arrangement, the third inner glass sheet 34 is arranged facing the interior of the vehicle and the first outer glass sheet 30 is arranged facing the exterior of the vehicle from where a projectile or impact could come. The second, middle glass sheet 32 is interpolated between the outer glass sheet 30 and the inner glass sheet 34. Between the outer glass sheet 30 and the middle glass sheet 32, a polyurethane layer 31 extends as a laminating layer, producing a laminate between the outer glass sheet 30 and the middle glass sheet 32. The polyurethane layer 31 or film of polyurethane is sized to fully cover the outer glass sheet 30. A further polyurethane layer is configured between the middle glass sheet 32 and the inner glass sheet 34, e.g. a further polyurethane layer 33, as a laminating layer which in turn produces a secure lamination between the middle glass sheet 32 and inner glass sheet 34 in contact therewith. The polyurethane layer 33 is sized to fully cover the adjoining surface of the inner glass sheet 34.

The outer glass sheet 30 and the inner glass sheet 34 protrude beyond the middle glass sheet 32 at the edge or periphery of the armoured glazing as shown in FIG. 3, resulting in a recess 39.1 being configured at the edge. In addition, the outer glass sheet 30 protrudes beyond the middle glass sheet 32 and inner glass sheet 34 at the edge or periphery of the armoured glazing as shown in FIG. 3, a projection 38 being formed at the edge which is declined by a stepped edge 39 to the inner glass sheet 34. In the region of the projection 38, the armoured glazing as shown in FIG. 3 is thus thinner than elsewhere. The projection 38 serves to engage a frame of the motor vehicle.

A sintered reinforcement 37 of AlON is applied to the inwardly facing surface 10 of the polyurethane layer 31 in the region of the projection 38 which may be configured as a three or more sided frame arranged at the edge of the armoured glazing in one piece and in forming a secure lamination with the outer glass sheet 30 by means of the polyurethane layer 31. At a peripheral face 39.2 of the armoured glazing the outer glass sheet 30, polyurethane layer 31 and AlON reinforcement 37 are sited flush. The AlON reinforcement 37 has a rectangular cross-section.

The AlON reinforcement 37 extends into the recess 39.1 or groove abutting obtusely against the face of the middle glass sheet 32. On its face the inner glass sheet 34 is provided with a seal 39.3, e.g. made of polyurethane which in addition fills out or seals cavities within the recess 39.1 between the adjoining surfaces of the AlON reinforcement 37, the middle glass sheet 32, the polyurethane layer 31 and the polyurethane layer 35 within the recess 39.1.

Shearing off of the projection 38 at the transition between the AlON reinforcement 37 and middle glass sheet 32 is prevented by the overlapping configuration of the inner glass sheet 34 relative to the surface of the AlON reinforcement 37 facing it.

In one example of the armoured glazing in accordance with the invention the outer glass sheet is 3 mm thick and the AlON reinforcement 37 and middle glass sheet 32 are each 3 mm thick. The polyurethane layers 31 and 33 and 35 are each 1 mm thick.

Furthermore, a sandwich of a polyurethane layer 35 and a polycarbonate layer 36 in this sequence, each of which can be 1 mm thick, covers the full inner surface of the armoured glazing.

In fabrication of the armoured glazing as shown in FIG. 3, first the AlON reinforcement 37 is produced as a closed, three-sided or peripheral i.e. four-sided AlON frame of powdery starting materials by the steps A to E in the method as an AlON part or blank, these steps in the method having already been explained in the description of the first embodiment as shown in FIG. 1.

In fabrication of the armoured glazing as shown in FIG. 3 in accordance with the invention, first the outer glass sheet 30 and middle glass sheet 32 are washed and dried on a transporting path, after which a sandwich structure is produced in a clean room and conditioned environment. In this arrangement the outer glass sheet 30 receives a covering of a polyurethane film as the polyurethane film 31, 1 mm thick and from a typical range for the film thickness between approx. 0.3 mm to 5 mm—manually, semi- or fully automatically on the inner surface of the outer glass sheet 30 and aligned. After this, the middle glass sheet 32 is placed on and aligned on the polyurethane layer 31 such that this produces a uniform stepped edge on all sides in the edge portion of the armoured glazing to be fabricated, and the outer glass sheet 30 protrudes beyond the middle glass sheet 32 in the edge portion. Then, the exposed peripheral surface of the polyurethane layer 31 at the edge is covered by the already produced AlON reinforcement 37 having a rectangular cross-section, the width of the AlON reinforcement 37 corresponding to the width of the frame-type exposed polyurethane layer 31 which is covered by the AlON reinforcement 37.

A thin strip of polyurethane film, which later forms part of the seal 39.3, is inserted between the obtuse adjoining faces of the middle glass sheet 32 and AlON edge reinforcement 37. This thin strip of polyurethane has the function of compensating or accommodating production tolerances or shifts between the AlON reinforcement 37 and the bordering or adjoining glass sheet 32.

From the thus prepared sandwich structure a pre-laminate is then produced with partially plasticized films under heating and compression in the pre-laminating oven, the location of the edge reinforcement 37 being maintained by corresponding spacers. In pre-treatment any air trapped in the sandwich structure is squeezed out more or less completely.

Then, the thus pre-treated sandwich structure is placed in an autoclave in which for a precisely defined compression and temperature cycle the individual components of the pre-treated sandwich structure are interconnected. The autoclave cycle is as already explained above with reference to the embodiment as shown in FIG. 1. On completion of the autoclave cycle the sandwich structure is removed.

In a next step, a polyurethane film as the polyurethane layer 33 is placed and aligned for full coverage on the now exposed surface of the middle glass sheet 32. Then, on this aligned film of polyurethane the inner, previously cleaned glass sheet 34 is placed and aligned such that the inner glass sheet 34 protrudes beyond the face of the middle glass sheet 32 in partly overlapping the AlON reinforcement 37 as evident from FIG. 3. Since the face of the inner glass sheet 34 protrudes beyond the middle glass sheet 32, a recess 39.1 is configured between the outer glass sheet 30 and the inner glass sheet 34 into which the AlON reinforcement 37 extends. After this, an angle of polyurethane film is placed on the face of the inner glass sheet 34, one leg of the angle engaging the recess 39.1 and the other leg fully covering the face of the inner glass sheet 34. This angled strip of polyurethane seals interspaces within the recess 39.1 and it thus forms part of the sealing 39.3 after fabrication of the armoured glazing in accordance with the invention.

The such prepared sandwich structure is then again treated in the pre-laminating oven under heat and compression to squeeze out more or less completely any air entrapped in or in the region of the middle sheet 33 and seal 39.3 and to achieve a partial plastification of the polyurethane film of the middle sheet 33 and polyurethane material of the seal 39.3. The resulting pre-laminated glazing is then again treated in an autoclave, again in the pressure and temperature cycle as explained above to obtain a durable and secure lamination of the pre-laminated glazing as a whole. After this, the thus treated laminated structure is removed from the autoclave.

The inner surface of the laminated structure such treated is then covered by a further film of polyurethane as polyurethane layer 35 and then, in this sequence by the polycarbonate layer 36. The thus prepared laminated structure is then again treated in the pre-laminating oven the same as above to remove the air from the laminated structure.

Then, the thus pre-treated laminated structure is placed in an autoclave in which for a precisely defined compression and temperature cycle the individual components of the pre-treated sandwich structure are interconnected, the autoclave cycle being substantially as already explained above, after which the completed armoured glazing is removed from the autoclave.

In a modification of the embodiment as shown in FIG. 3, the outer glass sheet 30 and/or the middle glass sheet 32 and/or the inner glass sheet can each be replaced by an AlON sheet.

In a further modification, a plurality of edge reinforcements made of AlON and/or metal, e.g. steel, may be provided at the edge of the armoured glazing of the invention

In other modifications, an armoured glazing of the invention may comprise a plurality of outer glass sheets or AlON sheets and/or a plurality of middle glass sheets or AlON sheets and/or a plurality of inner glass sheets or AlON sheets.

Referring now to FIG. 4, there is illustrated a further, fourth embodiment of the armoured glazing of the invention configured as a transparent laminated safety glazing comprising a plurality of glass sheets 40, 42 and 44 and a plurality of laminating layers 41, 43 and 45 as may be used, for example, as a moveable side window or windscreen of a motor vehicle.

In this arrangement the third inner glass sheet 44 faces the vehicle interior and the first outer glass sheet 40 faces the outside of the vehicle from where a projectile or impact could occur. The second middle glass sheet 42 is interpolated between the outer glass sheet 40 and the inner glass sheet 44.

A layer of polyurethane 41 extends between the outer glass sheet 40 and middle glass sheet 42, which forms a laminating layer between the outer glass sheet 40 and the middle glass sheet 42. The polyurethane layer 41 or polyurethane film is sized to fully cover the middle glass sheet 42. Between the middle glass sheet 42 and the inner glass sheet 44 there is configured e.g. a further polyurethane layer 43 in turn forming a secure lamination between these adjoining glass sheets 42 and 44. The polyurethane layer 43 is at least sized to fully cover the adjoining surface of the inner glass sheet 44.

The outer glass sheet 40 and the inner glass sheet 44 protrude towards each other in a flush manner beyond the middle glass sheet 42 at the edge or periphery of the armoured glazing as shown in FIG. 4, as a result of which a recess 51 is formed at the edge.

A sintered reinforcement 47 made of AlON is applied to the periphery of the armoured glazing as shown in FIG. 4 of AlON and it is configured on all sides or e.g. on three sides as a profile frame made in one piece at the edge of the armoured glazing and forming with the sandwich of the glass sheets 40, 42 and 44 a secure laminating layer 52 a secure lamination. The AlON reinforcement 47 has a peripheral main section 47.1 of rectangular cross-section, a likewise peripheral projection 48 jutting radially outwards at the periphery of the armoured glazing and a peripheral protrusion 50 or ridge which protrudes from the main section 47.1 into the recess 51 between the inner glass sheet 44 and the outer glass sheet 40 of the sandwich structure of the armoured glazing as shown in FIG. 4.

In the region of the projection 48 and a stepped edge 49 as shown, the armoured glazing as evident from FIG. 4 is thus thinner than elsewhere. The projection 48 serves to engage a frame of the motor vehicle.

Shearing off of the AlON reinforcement 47 at the transition between the AlON reinforcement 47 and the periphery of the laminate by an external force is prevented by the protrusion 50 engaging the recess 51.

In one example of the armoured glazing of the invention the outer glass sheet 40 is approx. 3 mm thick, and the projection 48 of the AlON reinforcement 47 is approx. 5 mm thick. The middle glass sheet 42 and the inner glass sheet 44 are each 3 mm thick. Each of the polyurethane layers 41, 43 and 45 is 1 mm thick, for example. The laminating layer 52 is made of polyurethane and is approx. 0.5 mm thick.

The complete inner surface of the armoured glazing is further covered with a polyurethane layer 45 and a polycarbonate layer 46 in this sequence of layers, each of these layers may be 1 mm thick.

In fabrication of the embodiment of the armoured glazing in accordance with the invention as shown in FIG. 4, firstly the AlON reinforcement 47 is made as a three-sided or four-sided continuous AlON frame of the powdery starting materials by the steps A to E in the method as the AlON part or AlON blank, these steps in the method having already been detailed in conjunction with the description of the first embodiment as shown in FIG. 1.

In fabrication of the armoured glazing as shown in FIG. 4, in accordance with the invention, first the outer glass sheet 40 and middle glass sheet 42 are washed and dried on a transporting path, after which a sandwich structure is produced in a clean, dust free and conditioned room environment. In this arrangement the outer glass sheet 40 receives a covering of a polyurethane film as the polyurethane layer 41 1 mm thick and from a typical range for the film thickness between approx. 0.3 mm to 5 mm—manually, semi- or fully automatically on the inner surface of the outer glass sheet 40 and aligned. After this, the middle glass sheet 42 is placed on and aligned on the polyurethane layer 41 such that a uniform peripheral step results and the outer glass sheet 40 protrudes edgewise beyond the middle glass sheet 42.

The thus prepared sandwich structure is then again treated in the pre-laminating oven under heat and compression to produce a pre-laminate with partially plasticised films. During this pre-treatment any entrapped air is squeezed out from the sandwich structure more or less completely.

Then, the thus pre-treated sandwich structure is placed in an autoclave in which for a precisely defined compression and temperature cycle the individual components of the pre-treated sandwich structure are interconnected. The autoclave cycle is explained above with reference to the embodiment as shown in FIG. 1. On completion of the autoclave cycle the sandwich structure is removed.

In a next step, a polyurethane film as polyurethane layer 43 is placed and aligned for full coverage on the now exposed surface of the middle glass sheet 42. Then, on this aligned film of polyurethane the inner, previously cleaned inner glass sheet 44 is placed and aligned such that the inner glass sheet 44 protrudes beyond the face of the middle glass sheet 42 flush with the outer glass sheet 40. Since the face of the inner glass sheet 44 and the outer glass sheet 40 protrude flush beyond the middle glass sheet 42 the recess 51 is formed between the outer glass sheet 40 and the inner glass sheet 44.

The thus prepared sandwich structure is then again treated in the pre-laminating oven under heat and compression to squeeze out more or less completely any air and to achieve partial plastification of the polyurethane film of the polyurethane layer 43. The resulting pre-laminated sheet is then again treated in an autoclave, again in the pressure and temperature cycle as explained above to obtain a durable, secure connection of the pre-laminated sheet as a whole. After this the thus treated laminate is removed from the autoclave.

A plurality of strip-shaped polyurethane films is placed on the peripheral surface of the laminate as just treated, these strips forming the laminating layer 52. The laminating layer 52 then receives the AlON edge reinforcement 47, the outer side of which ends flush with the exposed outer surface of the outer glass sheet 40 and the inner side of which ends flush with the surface of the inner glass sheet 44 facing inwardly without a projection. The thus prepared laminate is then again treated in the pre-laminating oven, as explained above, to remove the air from the laminate, after which the thus pre-treated laminate is placed in an autoclave in which with a precisely defined pressure and temperature cycle the individual components of the now existing and pre-treated sandwich structure are interconnected, using substantially the autoclave cycle as already explained.

Afterwards, the inner surface of the removed laminate is covered by the polyurethane layer 45 and polycarbonate layer 46 in this sequence and again treated in the pre-laminating oven and autoclave as already mentioned above. After this, the finished armoured glazing as shown in FIG. 4 is removed from the autoclave.

In one modification of the embodiment as shown in FIG. 4 the outer glass sheet 40 and/or the middle glass sheet 42 and/or the inner glass sheet 44 can each be replaced by an AlON sheet.

Referring now to FIG. 5 there is illustrated, by way of example, a further fifth embodiment of the armoured glazing in accordance with the invention configured as laminated safety glazing comprising a plurality of glass sheets 60 and 64, a sintered AlON sheet 62 and a plurality of laminating layers 61, 63 and 65 for use, for example, as a moveable side window or windscreen of a motor vehicle.

In this arrangement, the third inner glass sheet 64 is arranged facing the interior of the vehicle, the first outer glass sheet 60 facing away from the vehicle from where a projectile or impact could come. The second middle AlON sheet 62 is interpolated between the outer glass sheet 60 and the inner glass sheet 64.

A polyurethane layer 61 extends between the outer glass sheet 60 and the middle AlON sheet 62 and it forms a laminating layer between the outer glass sheet 60 and the middle AlON sheet 62. The polyurethane layer 61 or polyurethane film is sized to fully cover the outer glass sheet 60. Between the middle AlON sheet 62 and the inner glass sheet 64, there is configured e.g. a further polyurethane layer 63 as a laminating layer, in turn forming a secure lamination between these adjoining sheets 62 and 64. The polyurethane layer 63 is sized to fully cover the adjoining surface of the inner glass sheet 64.

The inner glass sheet 64 protrudes beyond the outer glass sheet 60, meaning that these sheets are not peripherally flush.

A sintered reinforcement 67 is provided at the periphery of the armoured glazing as shown in FIG. 5 and it is made of AlON configured at the edge of the armoured glazing as shown in FIG. 5 as a four-sided or e.g. three-sided, one-piece profile frame configured together with the AlON sheet 62 in one piece. The AlON reinforcement 67 has a main section 67.1 on all sides with a rectangular cross-section, a projection 68 likewise on all sides which radially projects edgewise at the periphery of the armoured glazing and a web section 67.2 on all sides which passes from the main section 67.1 into the AlON sheet 62.

In the region of the projection 68 and an adjoining stepped edge 69 the transparent armoured glazing as shown in FIG. 5 is thus thinner than elsewhere. The projection 68 serves to engage a frame of the motor vehicle.

Shearing off of the AlON reinforcement 67 at the transition between the AlON reinforcement 67 and the periphery of the laminate by an external force is prevented by the AlON reinforcement 67 being configured with the middle AlON sheet 62 as a one-piece AlON part and by the glass sheets 60 and 64 not being flush peripherally. Shearing off of the projection 68 by an external force is prevented by the projection 68 being configured extra thick and strong.

In one example of the armoured glazing of the invention as shown in FIG. 5 the outer glass sheet 60 is approx. 3 mm thick and the projection 68 of the AlON reinforcement 67 is approx. 5 mm to 8 mm thick. The middle AlON sheet 62 and the inner glass sheet 64 are each 3 mm thick. Each of the polyurethane layers 61, 63 and 65 is e.g. 1 mm thick.

The completely inner surface of the armoured glazing is further covered with a polyurethane layer 65 and a polycarbonate layer 66 in this sequence of layers, each of which may be 1 mm thick.

In fabrication of the armoured glazing as shown in FIG. 5 first the AlON reinforcement 67 is produced as a closed, multi-sided AlON frame together with the AlON sheet 62 of powdery starting materials by the steps A to E in the method as an AlON part or blank, these steps in the method having already been explained in the description of the first embodiment as shown in FIG. 1.

In fabrication of the armoured glazing as shown in FIG. 5 in accordance with the invention first the outer glass sheet 40, the AlON part 80 with the AlON edge reinforcement 67 and the middle AlON sheet 62 and the inner glass sheet 64 are washed and dried on the move in assembly, after which a sandwich structure is produced in a clean room conditioned environment. In this arrangement a polyurethane film as the polyurethane layer 61, 1 mm thick and from a typical range for the film thickness between approx. 0.3 mm to 5 mm—manually, semi- or fully automatically inserted and aligned in a recess 81 of the AlON part 80 for full coverage. After this, the outer glass sheet 60 is inserted in the recess 81 on the polyurethane layer 61.

Then a further film of polyurethane as polyurethane layer 63 again 1 mm thick—from a typical range for the film thickness between approx. 0.3 mm to 5 mm—is inserted and aligned manually, semi- or fully automatically for full coverage in a further recess 82 of the AlON part 80, after which the inner glass sheet 64 is inserted in the further recess 82 on the polyurethane layer 63.

From the thus prepared sandwich structure a pre-laminate with partially plasticized films is then produced in the pre-laminating oven under heat and compression. During this pre-treatment any entrapped air is squeezed out from the sandwich structure more or less completely.

Then, the thus pre-treated sandwich structure is placed in an autoclave in which for a precisely defined compression and temperature cycle the individual components of the pre-treated sandwich structure are interconnected. The autoclave cycle is as already explained above with reference to the embodiment as shown in FIG. 1. On completion of the autoclave cycle the sandwich structure is removed.

After this the polyurethane layer 65 and polycarbonate layer 66 in this sequence are placed on the inner surface of the removed laminated structure and again treated in the pre-laminating oven and autoclave as already explained above. Then finished armoured glazing as shown in FIG. 5 can then be removed from the autoclave.

In a modification of the embodiment as shown in FIG. 5 the outer glass sheet 60 and/or the inner glass sheet 64 can each be replaced by a further AlON sheet, resulting in the armoured glazing of the invention as shown in FIG. 5 being adaptable to differing ballistic performance requirements.

1. Armoured glazing, particularly for use as a moveable side window of a motor vehicle, characterized by at least one sheet of an optically transparent, sintered ceramic material.

2. The armoured glazing as set forth in claim 1, characterized in that the ceramic material is aluminum oxynitride (AlON).

3. The armoured glazing as set forth in claim 1, characterized in that the armoured glazing comprises a plurality of sheets (1, 3, 5) and laminating layers (2, 4) in a stacked arrangement, at least one laminating layer being arranged between two each facing sheets to join the two sheets.

4. The armoured glazing as set forth in claim 3, characterized in that the armoured glazing comprises at least two sheets laminated, at least one of the sheets being an AlON sheet (3),
that a first, outer sheet (1) is made of AlON or glass and that a second sheet (3) inward of the first sheet is made of AlON or glass,
that a laminating layer (2) between the first sheet (1) and the second sheet (3) is made of polyurethane, polyvinylbutyral, ethylene vinyl acetate, polyester, polyethylene or an acrylic plastic material.

5. The armoured glazing as set forth in claim 3, characterized in that the armoured glazing comprises at least three laminated sheets (1, 3, 5), at least one of the sheets (3) being an AlON sheet,
that a first outer sheet (1) is made of AlON or glass, that a second sheet (3) following the first sheet and being located more inwardly is made of AlON or glass,
that a first laminating layer (2) between the first sheet and the second sheet is made of polyurethane, polyvinylbutyral, ethylene vinyl acetate, polyester, polyethylene or an acrylic plastic material,
that a third sheet (5) following the second sheet and being located more inwardly is made of AlON or glass, and
that a second laminating layer (4) between the second sheet (3) and the third sheet (5) is made of polyurethane, polyvinylbutyral, ethylene vinyl acetate, polyester, polyethylene or an acrylic plastic material.

6. The armoured glazing as set forth in claim 1, characterized by a stepped edge (8) configured at a periphery of the armoured glazing, and a projection (9) for engaging the armoured glazing in a frame (10) or door frame.

7. The armoured glazing as set forth in claim 6, characterized in that the projection (9) is made of AlON.

8. The armoured glazing as set forth in claim 7, characterized in that the outer first sheet (1) is made of AlON, configured in one piece with the projection (9).

9. The armoured glazing as set forth in claim 7, characterized in that the second sheet (3) following the first sheet further inwardly is made of AlON and configured in one piece with the projection (9).

10. The armoured glazing as set forth in claim 7, characterized in that the third sheet (5) following the second sheet further inwardly is made of AlON and configured in one piece with the projection (9).

11. Armoured glazing, particularly for use as a moveable side window of a motor vehicle and comprising in layers a plurality of sheets (30, 32, 34) and laminating layers, at least one laminating layer (31, 33) being arranged between each two successive sheets to join that two sheets, a stepped edge (39) configured at the periphery of the armoured glazing and a projection (38) for engaging the armoured glazing in a frame (10) or door frame, and featuring an edge reinforcement (31) covering at least the inside surface of the projection (38), in the region of the stepped edge (39) a recess (39.1) being configured at the periphery of the armoured glazing into which the edge reinforcement (31) extends, characterized in that the edge reinforcement (31) is a sintered ceramic part.

12. The armoured glazing as set forth in claim 11, characterized by at least one outer sheet (30), at least one inner sheet (34) and at least one middle sheet (32) arranged between the outer sheet (30) and the inner sheet (34), the outer sheet (30) protruding beyond the middle sheet or beyond the other sheets to form the projection (38) at the edge or periphery of the armoured glazing, the inner sheet (34) protruding in the region of the projection (38) beyond the middle sheet (32) to form the recess (39.1) between the inner sheet (34) and the outer sheet (30), and the edge reinforcement (37) being made of aluminum oxynitride (AlON) as sintered ceramic material.

13. The armoured glazing as set forth in claim 11, characterized in that the edge reinforcement (37) is attached by means of a layer of polyurethane, polyvinylbutyral, ethylene vinyl acetate, polyester, polyethylene or an acrylic plastic material to the adjoining glass sheet or outer glass sheet.

14. The armoured glazing as set forth in claim 11, characterized in that the edge reinforcement (37) adjoins a peripheral side of the middle sheet (33).

15. The armoured glazing as set forth in claim 11, characterized in that the edge reinforcement (37) is configured as a planar strip as a planar circumferential frame or frame portion of the armoured glazing.

16. The armoured glazing as set forth in claim 11, characterized in that the inner glass sheet (34) is made of transparent sintered ceramic, preferably AlON.

17. The armoured glazing as set forth in claim 16, characterized in that middle sheet and the edge reinforcement of the armoured glazing are made in one piece of transparent, sintered ceramic, preferably AlON.

18. The armoured glazing as set forth in claim 11, characterized in that the outer sheet (30) is made of glass or transparent, sintered ceramic, preferably AlON.

19. The armoured glazing as set forth in claim 11, characterized in that the inner sheet (34) is made of glass or transparent, sintered ceramic, preferably AlON.

20. Armoured glazing comprising a laminate of sheets (40, 42, 44) and laminating layers (41, 43), at least one laminating layer being arranged between two each successive sheets to laminate the sheets and laminating layers together, and a stepped edge (49) configured at the periphery of the armoured glazing and a projection (48) for engaging the armoured glazing in a frame (10) or door frame, characterized in that the projection (48) is made of a sintered ceramic.

21. The armoured glazing as set forth in claim 20, characterized in that the sintered ceramic is aluminum oxynitride (AlON).

22. The armoured glazing as set forth in claim 20, characterized by a frame (47) extending continuously along at least part of the periphery of the armoured glazing and including the projection (48).

23. The armoured glazing as set forth in claim 22, characterized in that the frame (47) is a sintered ceramic part.

24. The armoured glazing as set forth in claim 20, characterized in that the frame (47) is configured in one piece with the projection (48).

25. The armoured glazing as set forth in claim 20, characterized by at least one ballistic sheet having an edge periphery or a ballistic laminate (40, 42, 44) having an edge periphery, the frame (47) being attached to the edge periphery of the ballistic sheet or of the ballistic laminate.

26. The armoured glazing as set forth in claim 25, characterized in that the frame or partial frame is applied to the periphery of the ballistic sheet or laminate by means of a layer of polyurethane, polyvinylbutyral, ethylene vinyl acetate, polyester, polyethylene or an acrylic plastic material.

27. The armoured glazing as set forth in claim 20, characterized in that the laminate has at its periphery a recess (51) and the frame (47) has a ridge (50) extending into the recess (51).

28. The armoured glazing as set forth in claim 27, characterized in that the laminate (40, 42, 44) has at least one outer sheet (40), at least one inner sheet (44) and at least one middle sheet (42) interpolated between the outer sheet and inner sheet, the outer sheet and the inner sheet protruding beyond the middle sheet at the periphery of the laminate to form the recess (51).

29. The armoured glazing as set forth in claim 28, characterized in that the outer sheet protrudes beyond the inner sheet at the periphery of the armoured glazing.

30. The armoured glazing as set forth in claim 28, characterized in that the inner sheet (64) protrudes beyond the outer sheet (60) at the periphery of the armoured glazing.

31. The armoured glazing as set forth in claim 25, characterized in that the frame (47) covers the full periphery of the laminate.

32. The armoured glazing as set forth in claim 25, characterized in that the frame (47) is flush with the outer surface of the laminate or of the ballistic sheet.

33. The armoured glazing as set forth in claim 20, characterized in that the frame (47) and at least one (62) of the sheets of the laminate are configured in one piece.

34. The armoured glazing as set forth in claim 33, characterized in that the frame (67) and the middle sheet (62) of the laminate are configured in one piece.

35. The armoured glazing as set forth in claim 33, characterized in that the frame and the outer sheet of the laminate are configured in one piece.

36. The armoured glazing as set forth in claim 33, characterized in that the frame and the inner sheet of the laminate are configured in one piece.

37. The armoured glazing as set forth in claim 20, characterized in that at least one of the sheets of the laminate is made of a ballistic glass.

38. The armoured glazing as set forth in claim 20, characterized in that its inner surface is provided with a layer of polycarbonate (46).

39. The armoured glazing as set forth in claim 20, characterized in that its inner surface is provided with a sequence of layers (45, 46) of polyurethane and polycarbonate.
